(19) United States
(12) Patent Application Publication
(10) Pub. No.: US 2016/0078493 A1
(43) Pub. Date: Mar. 17, 2016

(54) CONFERRING HEALTH RELATED SERVICES OR ITEMS IN EXCHANGE FOR PARTICIPATION IN OPT-IN ADVERTISING

(71) Applicant: MOZIDO, Dallas, TX (US)

(72) Inventor: Michael A. Liberty, Windermere, FL (US)

(21) Appl. No.: 14/945,241

(22) Filed: Nov. 18, 2015

Related U.S. Application Data
(63) Continuation-in-part of application No. 13/644,312, filed on Oct. 4, 2012.
(60) Provisional application No. 61/543,683, filed on Oct. 5, 2011.

(51) Int. Cl. G06Q 30/02; G06Q 20/36

(52) U.S. Cl. CPC G06Q 30/0269; G06Q 20/36; G06Q 50/22

(57) ABSTRACT

A method for managing network-based electronic commerce digital communications and associated user-health information can comprise accessing health related information for a user of an electronic payment system. The method can also comprise determining based upon the health related information, a particular health attribute of the user. The method can further comprise matching the metadata associated with an advertisement campaign indicator with the particular health attribute of the user. Additionally, the method can comprise matching information associated with an interactive object with the particular health attribute of the user. The method can comprise generating a benefit data structure that comprises a user-interaction tracking metric. Further, the method can comprise detecting a user interaction with the interactive object within the mobile wallet application. Based upon the detecting interaction, the method can comprise updating the user-interaction tracking metric.

### CROSS-REFERENCE TO RELATED APPLICATIONS

This application is continuation-in-part of U.S. application Ser. No. 13/644,312, entitled “Conferring Health Related Services or Items in Exchange for Participation in Opt-in Advertising”, filed on Oct. 4, 2012, which claims priority to and the benefit of U.S. Provisional Application Ser. No. 61/543,683, entitled “Conferring Health Related Services or Items in Exchange for Participation in Opt-in Advertising”, filed on Oct. 5, 2011. The entire contents of each of the above applications is incorporated herein by reference in their entireties.

### BACKGROUND

Mobile phones and other digital devices have become increasingly popular in recent years. These devices are used on a daily basis for a variety of different tasks. For instance, mobile devices allow users to check email, send and receive instant messages, check calendar items, take notes, set up reminders, browse the internet, play games or perform any number of different actions using specialized applications or “apps”. These applications allow mobile devices to communicate with other computer systems and perform a wide variety of network-connected tasks previously not possible with a mobile device.

### BRIEF SUMMARY

Embodiments described herein are directed to providing a health related service in exchange for participating in opt-in advertising. A user may opt-in to receive some form of advertising on his or her phone. The advertising may appear in a mobile wallet application used to pay for goods or services. The advertising may be related to health products and/or services. The user has an account with a mobile payment system that provides the mobile wallet application. The mobile payment system can provide the user with a variety of different functionality including purchasing items along with one or more of depositing funds, withdrawing funds, transferring funds, and other functions. Accordingly, the user can use a digital device (e.g., a computer or mobile phone) to interact with the electronic payment system to pay for goods and/or services.

In one embodiment, a method for managing network-based electronic commerce digital communications and associated user-health information can comprise accessing health related information for a user of an electronic payment system. The method can also comprise determining based upon the health related information, a particular health attribute of the user. The method can further comprise matching the metadata associated with at least one of the one or more advertisement campaign indicators with the particular health attribute of the user. Additionally, the method can comprise matching information associated with an interactive object with the particular health attribute of the user. The method can comprise generating a benefit data structure that comprises a user-interaction tracking metric. Further, the method can comprise detecting a user interaction with the interactive object within the mobile wallet application. Based upon the detecting interaction, the method can comprise updating the user-interaction tracking metric.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a monetary transaction system architecture in which embodiments described herein may operate.

FIG. 2 illustrates an alternate example embodiment of a monetary transaction system.

FIG. 3 illustrates an example screenshot from a mobile wallet application.

FIG. 4 illustrates an example data flow for providing a health related service in exchange for participating in opt-in advertising.

FIG. 5A illustrates another example embodiment of a monetary transaction system.

FIG. 5B illustrates an example embodiment of a benefit data structure.

FIG. 6 illustrates an example embodiment of a user interface within a monetary transaction system.

FIG. 7 illustrates another example embodiment of a user interface within a monetary transaction system.

FIG. 8 illustrates an alternate example embodiment of a user interface within a monetary transaction system.

FIG. 9 illustrates another example data flow for providing a health related service in exchange for participating in opt-in advertising.

### DETAILED DESCRIPTION

Embodiments of the present invention extend to methods, systems, and computer program products conferring health related services or items in exchange for participation in opt-in advertising. Embodiments of the invention include providing disruptively priced or free health related services to a digital device. Embodiments also include providing digital data (e.g., coupons or vouchers) for obtaining disruptive priced or free health related items (e.g., consumer goods or groceries) to a digital device.

Embodiments described herein are directed to providing health related services and items in exchange for participating in opt-in advertising. A user may opt-in to receive some form of advertising on their phone. The advertising may appear in a mobile wallet application that is used to pay for goods or services. The advertising may be related to health products and/or services. The user has an account with a mobile payment system that provides the mobile wallet application. The mobile payment system can provide the user with a variety of different functionality in addition to purchasing items including depositing funds, withdrawing funds, transferring funds, and other functions. Accordingly, the user can use a digital device (e.g., a computer or mobile phone) to interact with the electronic payment system to pay for goods and/or services.

In one embodiment, an electronic payment system receives health related information from a user of the electronic payment system. The health related information includes an indication that the user is initiating participation in opt-in advertising sent from the electronic payment system in exchange for health related services. The user has a digital device and a mobile wallet account at the electronic payment system, and the mobile wallet account is accessible to the user through a mobile wallet application running on the user's digital device. The electronic payment system sends interactive advertisements to the user's mobile wallet application for presentation to the user and receives inputs from the user at the digital device, where at least one of the inputs provides interaction with the presented interactive advertisements. The electronic payment system determines that the user's interactions with the presented advertisements warrant conferring a health related benefit to the user, and indicates to the user that the benefit is available for subsequently purchased health related items.

In exchange for a health related benefit, the user opts in to receive advertisements, coupons, vouchers, promotions, Buy One Get One (“BOGO”) offers from the electronic payment system. For example, the user can receive a reduced cost or free health related service or a reduced cost or free health related item in exchange for participating in opt-in advertising from the electronic payment system. Upon the user's agreement to participate in opt-in advertising, the electronic payment system may be permitted to store (e.g., by capturing purchase orders), track, and analyze items that the user purchases through their account with the electronic payment system. The electronic payment system stores and maintains a list of a user's purchased items in a data warehouse. In some embodiments, an electronic payment system stores, tracks, and analyzes health related information in a HIPAA compliant manner. For example, health related information can be stored, tracked and analyzed in accordance one or more portions of the Health Insurance Portability and Accountability Act (“HIPAA”), such as, for example, the HIPPA privacy rules.

The electronic payment system analyzes the users purchasing habits (potentially in a HIPAA compliant manner) to identify advertisements and/or promotions that may be of interest to the user. In some embodiments, the advertisements and/or promotions can be for items the user has purchased. In other embodiments, the advertisements and/or promotions can also be for items related to items the user has purchased. For example, if user has purchased a particular brand of razor, advertisements for the brand's shaving cream can be identified. Advertisements for related items can be used for cross-promotion. The advertisements/promotions may or may not be for health related products or services.

From time to time, at specified intervals, or based on location (e.g., having a coupon for a merchant this is with a specified proximity) the electronic payment system sends identified advertisements and/or promotions to the user's digital device. When specified advertising thresholds are satisfied (e.g., a specified number and/or type of advertisements and/or promotions are presented, whether or not the advertisements and/or promotions are health related), the electronic payment system confers a health related benefit on the user's account. For example, the electronic payment system can provide the user's account with a low cost (e.g., reduced fee) or free health related service, such as, for example, one reduced cost or free blood pressure check. Alternately, the electronic payment system can provide the user's account with a coupon or voucher for an item (e.g., a reduced cost or free prescription refill).

In some embodiments, a client application for the electronic payment system runs on the user's digital device. The user interacts with the electronic payment system through the client application. From a screen of the client application, the user can agree to accept opt-in advertising. Accordingly, embodiments of the invention essentially permit a user to self-monetize themselves through their digital device.

Embodiments of the invention include mobile telephones interoperating with an electronic payment system, such as, for example, a mobile wallet, to purchase goods and/or services. Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, special purpose processing device, to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones (having various different capabilities and features), PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

An electronic payment system architecture can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

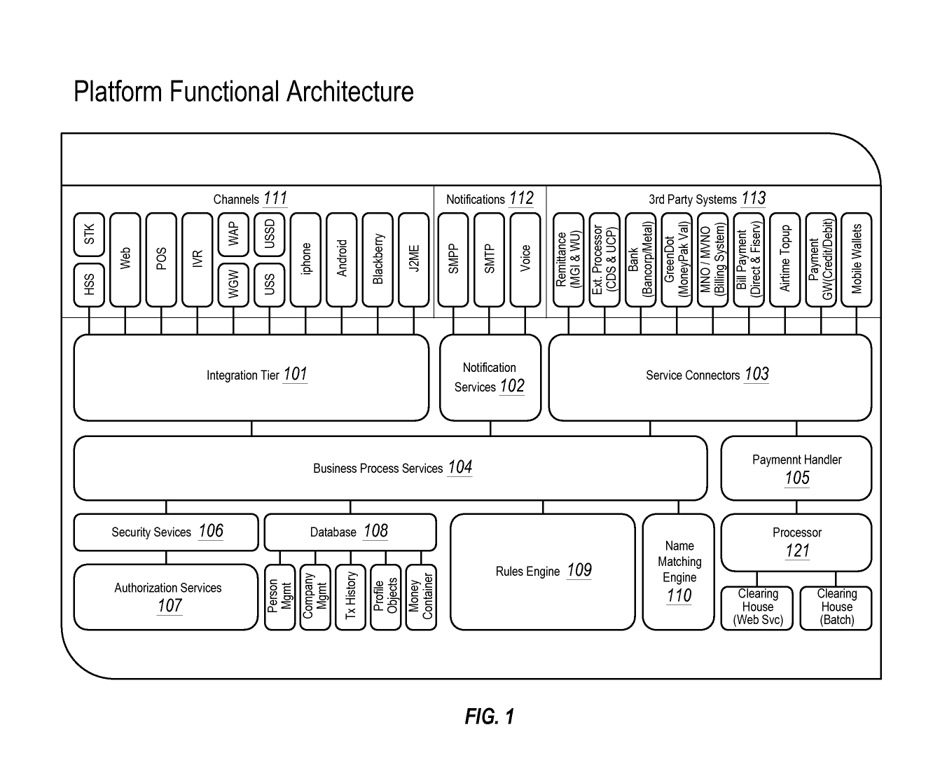

FIG. 1 illustrates an example system architecture for a mobile wallet platform. Integration tier 101 is configured to manage mobile wallet sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors. Service connectors 103 can implement security measures (e.g., encryption, digital signatures, certificates, etc.) to insure that any notifications including health related information are transferred in a HIPAA compliant manner.

In additional to the expressly depicted 3^{rd} party systems, one or more other 3^{rd} party systems can store health related information for a mobile wallet user in a HIPAA compliant manner. For example, a prescription database can store information about a user's medications and refills for one or more prescriptions. A medical database can store information about a user's health conditions. Thus, information from a HIPAA compliant database can be pulled into the electronic payment system in a HIPPA compliant manner based on a user's desire to receive health related benefits.

The scope of accessed health related information accessed by the electronic payment system is fully configurable and/or adjustable by a user. Thus, a user can choose to make as much or as little health related information about themselves available to the electronic payment system. For example, a user could indicate any combination of a medical condition, a type of prescribed medication, or simply that they have a prescription with refills. Alternately and/or in combination, a user can directly input such health related information in to the electronic payment system (e.g., for storage in a profile). Thus, when appropriate, user entered information can be received in a HIPAA compliant manner and user profile storage can be maintained in a HIPAA compliant manner.

Security services 106 are configured to perform subscriber authentication (e.g., by challenging a user for one or more of a user name, a password, an address, a phone number, etc., for the user). Authorization services 107 are configured to perform client authorization, such as, for example, using a database-based Access Control List (“ACL”) table. Security services 106 and authorization services 107 can interoperate to insure that any health related information is accessed in a HIPAA compliant manner. For example, security services 106 and authorization services 107 can help insure that health related information for a user of an electronic payment system is only accessed by the user.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints, compliance with one or more portions of the Health Insurance Portability and Accountability Act (“HIPAA”), etc.

Name matching engine 110 is configured to match different objects according to specified configuration rules. Matching engine 110 can be use to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

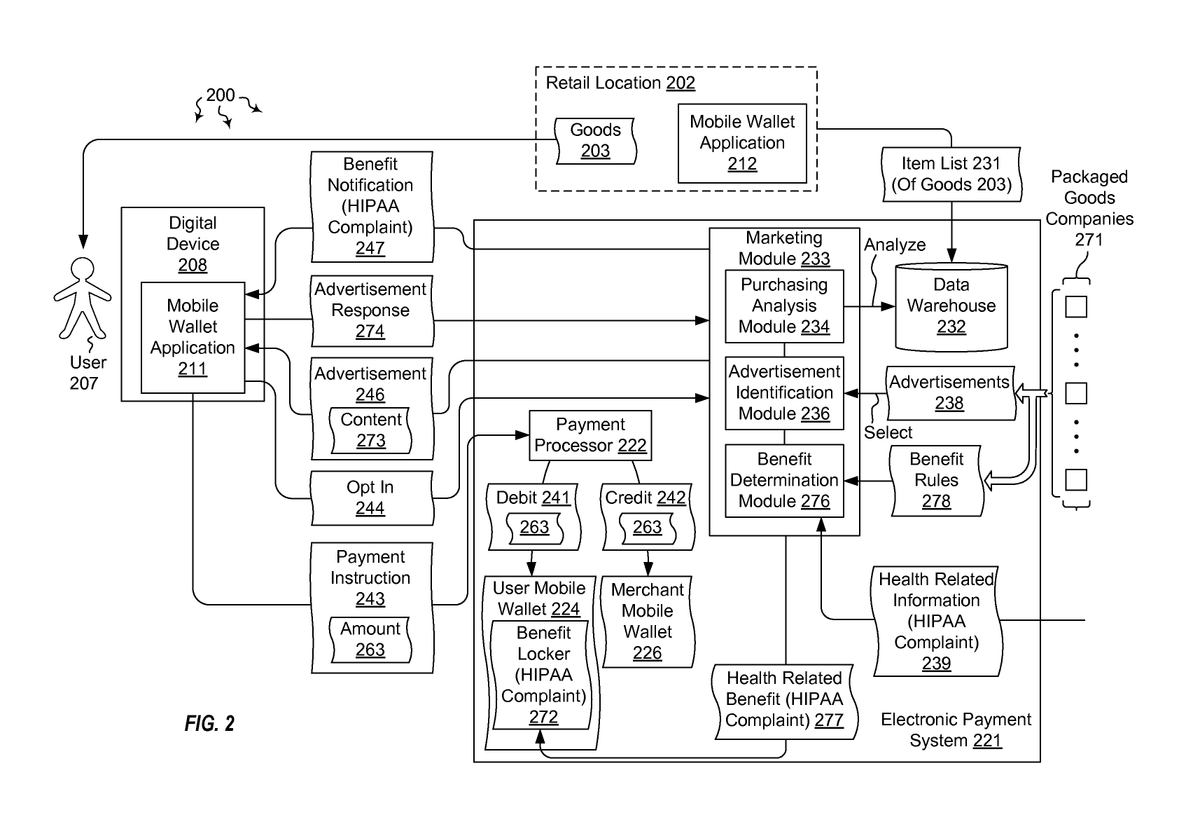

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below. These services will be described in greater detail below with regard to system FIGS. 1 and 2

FIG. 2 depicts a computer system architecture 200 for conferring health related services or items in exchange for participating in opt-in advertising. As depicted in FIG. 2, computer architecture 200 includes digital device 208, retail location 202 (e.g., a drug store or pharmacy), and electronic payment system 221. Digital device 208 further includes mobile wallet application 211. Retail location 202 further includes mobile wallet application 212. Electronic payment system 221 further includes marketing module 233, data warehouse 232, advertisements 238, payment processor 222, user mobile wallet 242 (user 207's mobile wallet), and merchant mobile wallet 226 (retail location 202's mobile wallet).

Generally, each company in packaged goods companies 271 can send advertisement data (which may or may not be for health related items) to electronic payment system 221. Advertisements 238 represent the collection of advertisement data sent from packaged goods companies 271. Each company in packaged goods companies 271 can also submit benefit rules to electronic payment system 221. Benefit rules 278 represent the collection of benefit rules sent from packaged goods companies 271. Benefit rules 278 define when a benefit, such as, for example, a free health related service, a coupon, a promotion, etc, is to be granted to a user of electronic payment system 221. For example, in response to completing a questionnaire linked to a product advertisement, a user can be given a coupon for the product or a related product.

In general, user 207 can use mobile wallet application 211 to pay for goods purchased at retail location 202. For example, user 207 can use mobile wallet application 211 to purchase goods 203. To pay for goods 203, mobile wallet application 211 can send payment instruction 243 in amount 263 to electronic payment system 221. Payment processor 222 can receive payment instruction 243. In response, payment processor 222 can debit 241 user mobile wallet 224 by amount 263. Payment processor 222 can also credit 242 merchant mobile wallet 226 by amount 263.

User 207 can use mobile wallet application 211 to participate in opt-in advertising. For example, user 207 can use mobile wallet application 211 to send opt-in 244 to electronic payment system 221. Advertising module 233 can receive opt-in 244 and record that mobile wallet application 211 has opted in for advertising. As such, when user 207 makes a purchase using mobile wallet application 211, a list of purchased items is sent to electronic payment system 221. For example, upon purchasing goods 203, item list 231 is sent to electronic payment system 221 and stored in data warehouse 232.

Purchasing analysis module can analyze user 207's purchases, including item list 231. From the analysis, purchase analysis module 234 can identify items or categories of items user 207 may be interested in. The items can be items user 207 has purchased in the past (e.g., an item in goods 203) or items related to items user 207 has purchases in the past. Purchase analysis module 234 can indicate identified items or categories of items to advertisement identification module 236. Advertisement identification module 236 can select advertisements from advertisements 238 that correspond to the identified items or categories of items. For example, advertisement identification module 236 can select advertisement 246 for presentation at mobile wallet application 211. Advertisement 246 can be an advertisement for a product made by a company in packaged goods companies 271.

Advertising module 233 can send selected advertisements to mobile wallet application 211. For example, advertising module 233 can send advertisement 246 (e.g., related to an item in goods 203) to mobile wallet application 211. In general, advertisements can include interactive content. For example, advertisement 246 includes content 273. Content 273 can be a video, a link to a company website (e.g., for a company in packaged goods companies 271), a call to action, or some other content user 207 can interact with through digital device 208. User 207 can interact with content 273, for example, responding to questions in content 273. Advertisement response 274 can indicate how user 207 has interacted with content 273.

Based on advertisement response 274, benefit determination module 276 can determine if a benefit is to be conferred upon user 207. Benefit determination module 276 can refer to benefit rules 278 and/or to health related information 239 (maintained in a HIPAA compliant manner) when making a determination whether or not to confer a benefit. Thus, when user 207 interacts with advertisement 246 in a specified way (e.g., completes a survey, watches a video, etc.), benefit rules 278 can indicate that a benefit (e.g., health related benefit 277) is to be conferred upon user 207. For example, benefit determination module 276 can confer health related benefit 277 on user 207 in a HIPAA compliant manner. For example, when user 207 receives an advertisement for a razor and answers a questionnaire on how often they shave, the owner of electronic payment system 221 can confer a discounted or free prescription refill on user 207 in a HIPAA compliant manner.

In some embodiments, health related information 239 relates to one or more of: prescription compliance, chronic disease management, and a medication management program. As such, health related information 239 can come from a corresponding module (not shown), such as, for example, a prescription compliance module, a chronic disease tool, or a medication management module.

When a health related benefit is to be conferred on a user, the health related benefit can be stored in the user's benefit locker (also in a HIPAA compliant manner). For example, benefit determination module 276 can store health related benefit 277 in benefit locker 272 (part of user mobile wallet 224). Health related benefit 277 can be a coupon, voucher, or promotion for a health related item, a reduced cost or free health related service, etc.

Benefit determination module 276 can also track aggregate statistics, such as, for example, specified number and/or type of advertisements received, for advertisements presented at mobile wallet application 211. Health related benefits can also be conferred upon users based on the aggregate statistics. For example, benefit determination module 276 can confer a benefit upon user 207 in response to twenty advertisements being presented at mobile wallet application 211. Thus, conferred health related benefits can be company specified benefits or can be electronic payment system specified benefits. Electronic payment system 221 can notify a user when a health related benefit is conferred. For example, electronic payment system 221 can send benefit notification 247 in a HIPAA compliant manner to mobile wallet application 211 to indicate health related benefit 277 being stored in benefit locker 272.

Health related benefit 277 can relate to prescription compliance, chronic disease management, or medication management. For example, health related benefit 277 can be a free prescriptions refill to assist user 207 comply with prescriptions or keep up with a medication management program.

When user 207 makes subsequent purchases through user mobile wallet 224, electronic payment system 221 can automatically check benefit locker 272 for health related benefits related to any purchases items. If benefits for an item are identified, user 207 can be notified through mobile wallet application 211. For example, when re-filling a prescription, user 207 can be notified of a prescription refill discount stored in benefit locker 272. The user can then chose to use or mot use the refill discount. Accordingly, embodiments of the invention permit user 207 to self monetize digital device 208 through agreeing to participate in opt-in advertising.

Although not depicted, various other modules from the architecture of FIG. 1 can also be included electronic payment system 221. The modules expressly depicted in FIG. 2 can interoperate with these other modules as appropriate to facilitate desired functionality

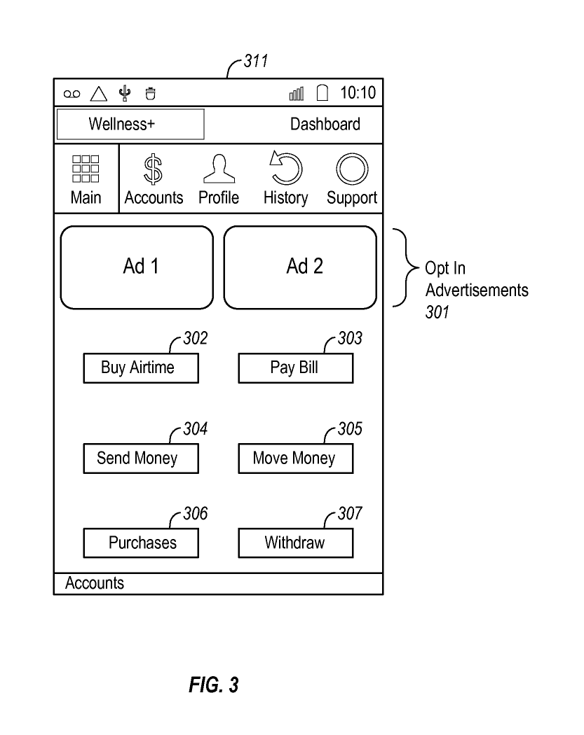

FIG. 3 depicts a screen shot of a mobile wallet client application 311. After a benefit has been conferred upon the user, the user may use the benefit when purchasing a corresponding product or service. Accordingly, as shown in FIG. 3, for example, if Ad 1 or Ad 2 (301) shows a name brand cold medication and the user interacts with the ad for that medication in some way, the company that produces the medication may send a coupon or other benefit to the user's mobile wallet. Then, when the user is at a retail location, the user may purchase that name brand cold medication using their mobile wallet (e.g. using the “Purchases” button 306). The coupon or other benefit sent by the cold medication producer will be automatically applied at checkout, such that the user obtains the medication for a discounted price. Many different coupons or other benefits may be stored in the user's benefit locker 272, and each of these may be applied automatically when the electronic payment system determines that the user is purchasing that product or service.

Still further, as mentioned above, the user may use their mobile wallet application 311 to perform other tasks such as adding airtime to their phone (302), paying a bill (303), sending money to another party (304), transferring money (305) or withdrawing money (307) at an agent branch, for example. Many other functions may be provided by the mobile wallet application. As such, buttons 302-307 are merely examples of possible buttons. Moreover, the look and feel of mobile wallet application 311 may be as illustrated in FIG. 3, or may be substantially different, or may be modified by the user. Accordingly, the layout shown in FIG. 3 is just one example of a possible button and advertisement layout. Many such layouts are possible, and may be different for each phone or digital device.

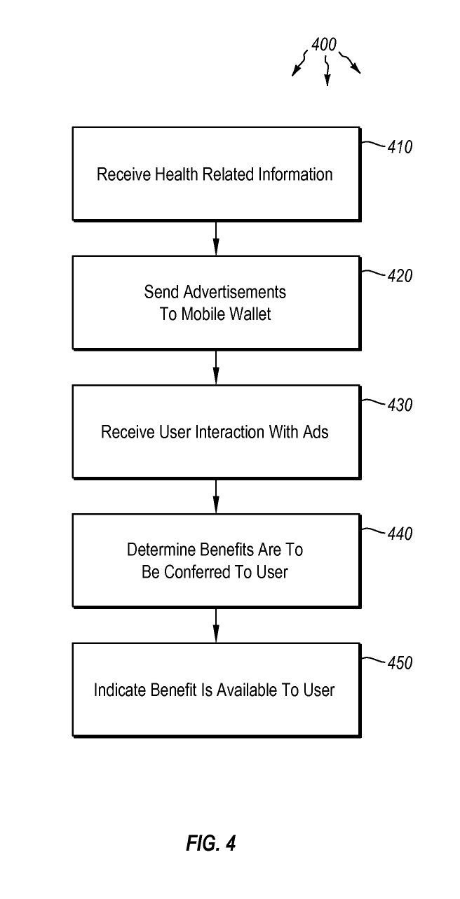

FIG. 4 describes an example flow diagram for a method 400. The method 400 includes various acts which will be described in conjunction with computing environment 200 of FIG. 2.

Method 400 includes an act of receiving health related information from a user of the electronic payment system, the health related information including an indication that the user is initiating participation in opt-in advertising sent from the electronic payment system in exchange for health related services, the user having a digital device and a mobile wallet account at the electronic payment system, the mobile wallet account being accessible to the through a mobile wallet application running on the user's digital device (act 410). For example, the electronic payment system 221 may receive (HIPAA compliant) health related information 239 from a user such as user 207. The information may include an opt-in indication 244 that indicates the user is willing to participate in receiving advertising on their mobile phone (e.g. within the mobile wallet application 211) in exchange for discounts, coupons or other benefits.

Method 400 further includes an act sending one or more interactive advertisements to the user's mobile wallet application for presentation to the user (act 420). Advertisements 238 may be sent to the user's digital device 208 which may be a mobile phone, a tablet, a laptop or any other type of digital device. As shown in FIG. 3, the ads 301 may be shown within the mobile wallet application 311. The ads may be shown substantially anywhere within the mobile wallet application. The ads may be any size, shape or duration, and may include audio, video, images, text or other media or content (e.g. content 273 within advertisement 246). The user 207 may interact with these ads through the mobile wallet, as shown below.

Method 400 includes an act of receiving one or more inputs from the user at the digital device, wherein at least one of the inputs provides interaction with the presented interactive advertisements (act 430). The user's interaction (e.g. ad response 274) with the advertisements may include playing a video, viewing an advertisement, answering one or more questions about a product, providing a rating or review of a product, playing a game within the advertisement or any other type of advertisement interaction. Each of the user's interactions with the ads may be tracked by the marketing module 233 and stored in data warehouse 232.

Method 400 also includes an act determining that the user's interactions with the presented advertisements warrant conferring a health related benefit to the user (act 440). The benefit may be selected from among a reduced cost or free health related service, a coupon, a voucher, and a buy one get one free offer, rewards points or other type of discount including a prescription refill discount. The benefit may be derived from and may be related to the health related information provided by the user. Accordingly, if the user indicated that they had a specific disease or sickness, advertisements may be sent to the user that are related to that ailment.

The electronic payment system 221 may record an indication that the health related benefit was conferred to the user. This record may be stored in data warehouse 232. Additionally or alternatively, the record of the conferred benefit may be stored in a brand locker associated with the user's mobile wallet account. The record may also indicate that the benefit conferred on the user was defined by a company that produces at least one of the items advertised in the presented advertisements (e.g. packaged goods company 271). Still further, the record of the benefit conferred on the user may indicate that the benefit was defined by the electronic payment system 221.

In some embodiments, determining that the user's interactions with presented advertisements warrants conferring a health related benefit to the user includes determining that a health related benefit is to be conferred on the user based on the user participating in a call to action contained in the content 273 of the advertisement 246. The benefit determining module 276 may determine that the user's participation is sufficient to receive a certain reward. In some cases, the amount of the benefit conferred to the user is proportional to the user's amount of interaction with the presented advertisements. Thus, if the user interacts more with the advertisements (e.g. watches more ad videos, fills out questionnaires, etc.), the user will receive more (or more valuable) rewards. The packaged goods companies or retail stores providing the coupons may determine which level of interaction achieves which level of benefits.

Once the amount of the health related benefits is determined by module 276, the benefits 277 are automatically applied to the user's mobile wallet account (and in some cases, specifically to the user's HIPAA compliant benefit locker 272. The benefits may be automatically applied at checkout when the user is using their mobile wallet to the purchase of at least one of the items that was advertised in the presented advertisements. The electronic payment system may indicate to the user that the benefit is available for subsequently purchased health related items (act 450). The indication may be sent to the user in a HIPAA compliant manner. In this manner, benefits may be provided to the user, the user may be notified of which benefits are available, and the benefits may be automatically used at checkout when using the mobile wallet 211 to pay for the item.

Embodiments of the invention can adhere to Know Your Customer (KYC) rules in the US by performing Customer Identification Program (CIP) checks as required by the Bank Secrecy Act and US PATRIOT Act. A minimum amount of information can be gathered about a customer, such as, for example, First Name, Last Name, Date of Birth, Government ID Type, Government ID Number, Address. The CIP processes are designed to validate customer identity against government blacklists and assists in the prevention of money laundering and terrorist financing. A combination of non-documentary and documentary verification can be used to ensure beyond a reasonable doubt the identity of the customer.

Non-Documentary Verification can occur through the presentment of the information that was collected from the user to an external third party, such as, for example, Lexis Nexis. Documentary Verification can occur if non-documentary verification fails, then the user is asked to present an unexpired government ID. Various differ forms of identification including Driver's license, Passport, Alien identification (e.g., green card or work visa), and Mexican Consular identification card, can be accepted.

Embodiments of the invention can perform Anti-Money Laundering (AML) and Combating the Financing of Terrorism (CFT) checks. AML and CFT checks can be performed using transaction monitoring methods to flag names and suspicious transactions for further investigation. The electronic payment system can perform AML and CFT checks on all electronic financial transactions to ensure that electronic funds are not being used for money laundering or terrorism. Transaction limits can be placed on user accounts. The transaction limits are fully configurable for each particular use case, channel and payment method that allows maximum flexibility to restrict higher risk use cases. Velocity checks can also be performed. Velocity Checks ensure that subscribers are not abusing the electronic payment system within the allowable limits.

In general, mechanisms for user authentication and authorization, data storage, and data transfer implemented by an electronic payment system can comply with relevant portions of the Health Insurance Portability and Accountability Act (“HIPAA”) to insure the privacy of health related information.

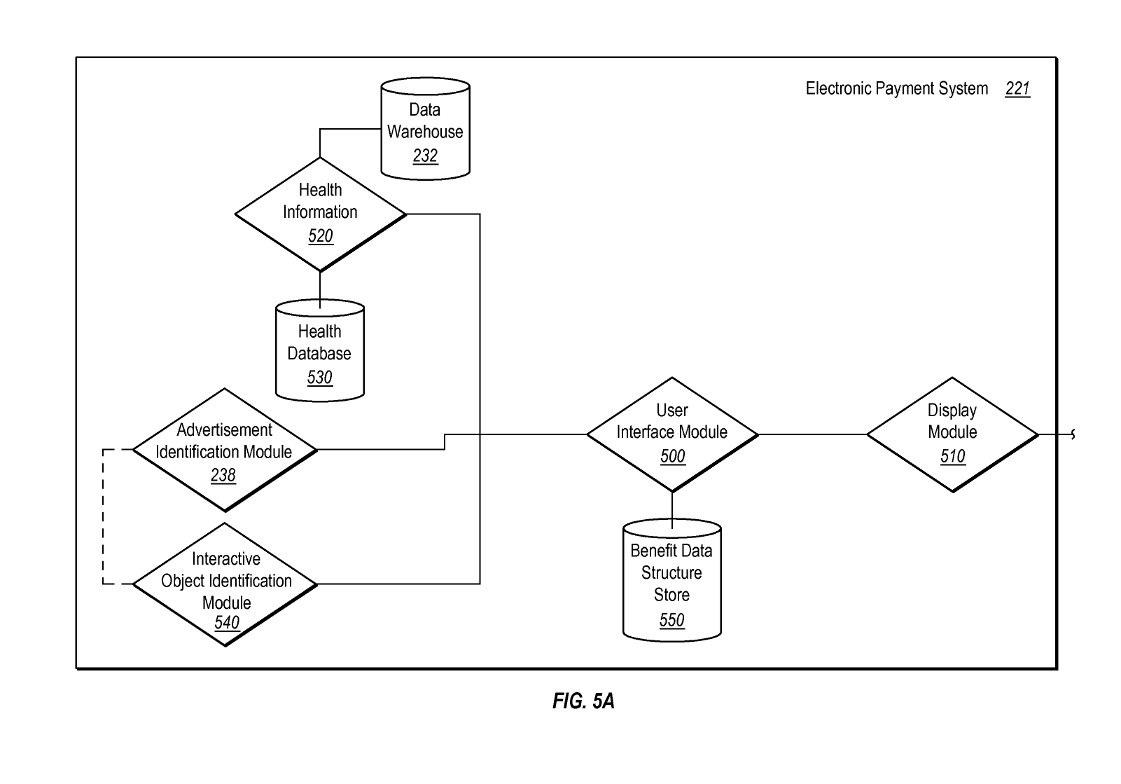

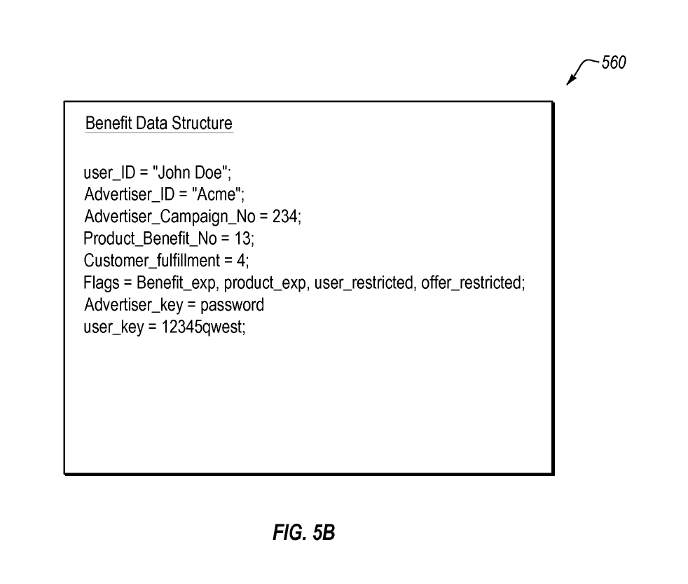

Additionally, at least one implementation of the present invention comprises an electronic payment system 221 that interacts with a user through a user interface. FIG. 5A depicts a system for generating a user interface and/or a data structure for managing a user's interaction with the electronic payment system 221. In particular, when preparing a user interface, the electronic payment system 221 can access a health information module 520 that can provide health related information for a user. The health information module 520 can gather health information, from a health database 530, that the user manually entered into the electronic payment system 221. Additionally, the health information module 520 can gather information from a third-party health information database, such an insurance company's website. Further in at least one implementation, the health information module 520 can gather information from a data warehouse 232 that contains financial transactions made by the user.

For example, the electronic payment system 221 can gather health related information based upon a user's prescription drug purchase history. The electronic payment system 221 may identify that a user purchases a particular prescription drug at a particular frequency. For instance, the electronic payment system 221 may identify transactions for a particular prescription drug at a pharmacy roughly every thirty days. After identifying that the drug is refilled a threshold number of times, the electronic payment system can store an indication that the user has a 30-day prescription for the particular drug.

Using the stored health-related information, the electronic payment system 221 can determine a particular health attribute of the user. For example, the determination may merely be that the user has a prescription for the purchased prescription drug. Similarly, the electronic payment system 221 may determine, as a health attribute, that the user has high blood pressure, based upon medical information that the user provided to the electronic payment system 221. Further, in at least one implementation, the electronic payment system 221 can intelligently deduce a health attribute based upon health-related information. For example, the electronic payment system 221 may identify, based upon transaction history, that the user has a prescription for a statin. Based upon the identified prescription, the electronic payment system 221 can associate a health attribute of high cholesterol with the user.

In addition to identifying a health attribute for a user, the electronic payment system 221 can also access and select, from an advertisement identification module 238, one or more advertisement campaign indicators. The advertisement campaign indicators may comprise a URL to an actual advertisement or may comprise an actual advertisement itself. Each of the one or more advertisement campaign indicators may be associated with metadata that describes an advertised health benefit of each of the advertisement campaign indicators. The advertised health benefit may comprise a service or a product and an associated financial discount or incentive, such as a coupon. For example, an advertised health benefit may comprise a free or discounted refill for a particular prescription drug.

Using metadata associated with the advertisement campaign indicators, the electronic payment system 221 can match an advertisement campaign indicator with a particular health attribute of the user. For example, the electronic payment system 221 may match an advertisement campaign indicator for an anti-inflammatory drug with a health attribute of the user that indicates that the user has arthritis.

In at least one implementation, before matching an advertisement campaign indicator with the particular health attribute of the user, the health information module 520 can access a compliance indicator that is associated with the particular health attribute of the user. The compliance indicator may indicate whether the user is in compliance with a particular health product or service. For example, the compliance indicator can indicate one or more of the following: the current validity of a prescription associated with the user and a current amount of the prescription that the user has on hand. As such, the compliance indicator can be used to prevent the electronic payment system from providing a user with the health benefit that the user should not receive. For instance, the compliance indicator may indicate that the user's prescription has lapsed or that the user has too much of a prescription drug on hand so that the user is not eligible for a refill. The information within the compliance indicator can be gathered from the user, from a third-party database of compliance information, or from a healthcare provider associated with the user.

Once an advertisement campaign indicator has been identified, the electronic payment system 221 can also access, from an interactive object identification module 540, information about one or more interactive objects. In at least one implementation, each of the one or more interactive objects may be associate with one or more advertisement campaign indicators. For example, the interactive objects and the advertisement campaign indicators may be provided by the same company. As such, a company can provide a collection of advertisement campaign indicators that are each associated with a wide-range of different health metadata. The company can also provide a wide range of different interactive objects that are also associated with various health attribute information. The electronic payment system 221 can then match the user to both an appropriate advertisement campaign indicator and an appropriate interactive object. The information about the interactive objects may describe a health attribute associated with each of the one or more interactive objects. For example, an interactive object may comprise a health questionnaire that can assist a drug maker in producing a particular drug. Additionally, an interactive object may comprise a video that advertises a particular health product or service. In at least one implementation, the interactive object can comprise a tracking code that can be scanned at a particular health facility to verify that the user visited the facility.

Based upon the information associated with each interactive object, the electronic payment system 221 can match an interactive object to a health attribute of the user. In at least one implementation, the electronic payment system 221 may match an interactive object to both a health attribute of the user and to an advertisement campaign indicator. For example, the electronic payment system 221 may identify that a user is associated with a health attribute of being diabetic. Based upon the identified user health attribute, the electronic payment system 221 may identify an advertisement campaign indicator for a glucose company. The advertisement campaign indicator may comprise metadata that indicates it is associated with diabetes. The electronic payment system 221 may further identify an interactive object that comprises a video advertisement for a blood glucose test. In at least one implementation, the particular interactive object that comprises the video advertisement for the blood glucose test may be associated with the advertisement campaign indicator because the blood glucose test is manufactured by the glucose company.

Once the electronic payment system 221 has identified a health attribute of a user, an advertisement campaign indicator, and an interactive object, the electronic payment system 221 can generate a benefit data structure 560 (shown in FIG. 5B). The benefit data structure 560 may comprise at least a user identification, an advertisement identification, an interactive object identification, and a user-interaction tracking metric. The benefit data structure 560 may also comprise various other data fields, such as but not limited to, an advertisement campaign identification, a specific advertisement identification, a specific benefit identification, a customer fulfillment tracker (also referred to herein as a “user-interaction tracking metric”), a public/private key combination, and/or various flags for managing the benefit data structure. Once created, the electronic payment system 221 can store the benefit data structure in a benefit locker 272 (also depicted in FIG. 5A as Benefit Data Structure store 550).

Additionally, implementations of the present invention can generate a user interface template with a user interface module 500. The generated user interface template may comprise a first visual indication of the particular health attribute of the user, a second visual indication of the at least one of the one or more advertisement campaign indicators, and a third visual indication of the interactive object. The user interface template may comprise a fully rendered user interface, general instructions for a user interface, URLs to the various user interface components, or various other user interface components.

Once the user interface template is created, the user interface module 500 can send, from the electronic payment system 221, the user interface template to the user's mobile wallet application for presentation to the user. For example, the display module 510 can communicate to a wireless network the user interface template. The user interface template can then be communicated wirelessly to the user's digital device for display. In at least one implementation, the electronic payment system 221 can also directly display the user interface template on a monitor.

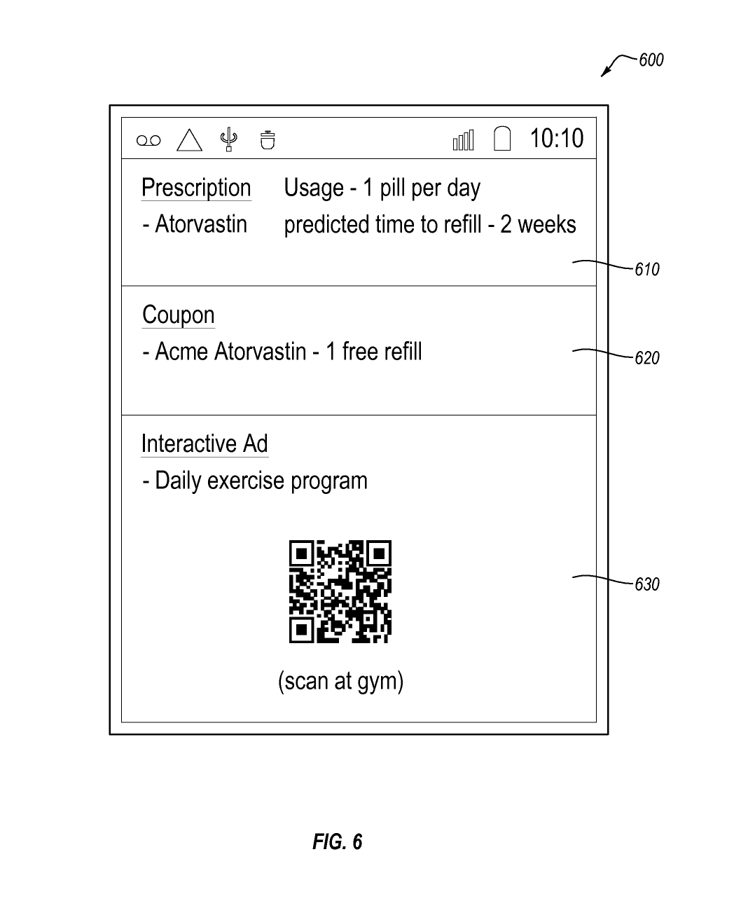

For example, FIG. 6 depicts an implementations of a user interface 600 that can be displayed on a user's digital device. In at least one implementation, the user interface may also comprise a health information entry interface (not shown) for entering health-related information for a user of an electronic payment system. The health information entry interface may comprise a health questionnaire, a data structure where various medical metrics can be entered, or any other user interface configured to receive the input of information.

Additionally, in at least one implementation, the user interface 600 can be configured to receive health-related information from the user through the mobile wallet application. In particular, the received health-related information may comprise information about purchases made through the mobile wallet application that relate to health products and services. For example, the health information module 520 may receive an indication that the user previously purchased a particular prescription drug. Additionally, the health information module 520 may receive an indication that the user purchased the same particular prescription drug approximately every 30 days for the last six months. Based upon the received information, the health information module 520 can infer that the user has a prescription for the particular drug that lasts approximately 30 days for each refill. In at least one implementation, the health information module 520 will verify that a particular purchase was made at least a threshold number of times before adding information relating to the purchase to the health-related information for the user. For instance, in at least one implementation, the health information module 520 will verify that a prescription is purchased at least four times before adding the information to the health-related information for the user.

Once the user interface template has been transmitted, or otherwise provided, to the user's digital device, the user's digital device can receive, through an API at an integration tier of the electronic payment system, the user interface template. The received user interface template can then be displayed within the mobile wallet application on the user's digital device. The user interface template can comprise a first visual indication 610 of a particular health attribute of the user. The particular health attribute may be associated with the health-related information. The user interface template can also comprise a second visual indication 620 of an advertisement campaign indicator. Additionally, the user interface template can comprise a third visual indication 630 of an interactive object that is associated with the health-related information. The interactive object may comprise one or more of: a video, a questionnaire, a request for the user to perform a specific action, a URL, or a request for a user to review a product.

As depicted, the first visual indication 610 of the particular health attribute of the user depicts a prescription that the user is taking. The health information module 520 may have identified the health attribute based upon information that the user explicitly entered, information gathered from a third-party database, or based upon inferences from the purchases that the user made over a period of time. Additionally, the first interface 610 can also depict a suggested prescription usage (“one pill per day”) and refill time for the prescription drug.

In at least one implementation, the second visual indication 620 of the advertisement campaign indicator comprises a visual indication of an advertised health benefit. The advertised health benefit may comprise a financial incentive to purchase a particular product or service. Additionally, the financial incentive may be applied by the mobile wallet application. For example, the financial incentive depicted in FIG. 6 (second visual indication 620) comprises a coupon for a free refill of Acme Atorvastin.

In at least one implementation, the third visual indication 630 of an interactive object may display a benefit activation requirement. The benefit activation requirement may comprise one or more of: a requirement to view an entire video, a requirement to complete a questionnaire, a requirement for the user to perform a specific action, a requirement for the user to visit a URL, or a requirement for a user to review a product. For example, the benefit activation requirement depicted in FIG. 6 requires the user to visit a gym. For example, the coupon (first visual indication 610) may only be issued to the user, once the user has visited the gym at least 10 times in a two-week period. The bar code within the third visual indication 630 may comprise a location authentication token as a means to verify whether the user actually visited a gym. For example, one or more gyms may be capable of scanning the bar code and transmitting the scanned code to the electronic payment system, such that once the user has attended the gym ten times the electronic payment system can activate the coupon for the user. In another exemplary embodiment, the Digital Device 208 is operable to automatically report its location using the Mobile Wallet Application 211 through a direct communication to the Electronic Payment System 221. In this example, the Digital Device 208 is configured to detect a transmitted beacon that indicates the current location to the Electronic Payment System. In another embodiment, the Digital Device 208 is operable to automatically determine its current location using geo-location services.

In at least one implementation, each time the user visits a gym and scans the code, the electronic payment system 221 can access the user's benefit data structure 560 and update a user-interaction tracking metric within the data structure. Once the user-interaction tracking metric reaches the predetermined fulfillment level, the electronic payment system can award the financial incentive to the user. Additionally, in an alternate implementation, the user-interaction tracking metric may comprise a timer. As the timer runs the value of the health benefit may decrease. Each time the user fulfills a benefit activation requirement, the timer can add time or slow down. For example, the benefit activation requirement may require the user to attend the gym as much as possible over the next week. The timer may decrement over time, but each time the user attends the gym the timer may add additional time or value to the user-interaction tracking metric. As such, the more frequently the user attends the gym the higher the worth of the health benefit will be at the end of the week. Accordingly, in at least one implementation, when the user performs a benefit activation requirement, the user-interaction tracking metric can be incremented or decremented. The final value of the user-interaction tracking metric can then be used to determine a final value of the health benefit. For instance, a coupon value may vary based upon the final user-interaction tracking metric value.

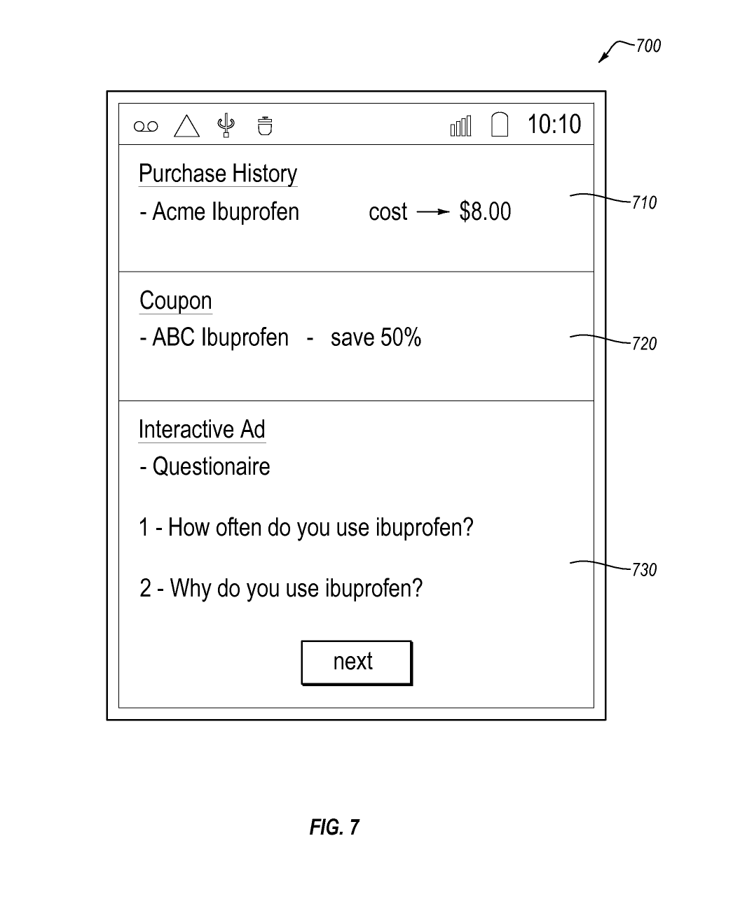

FIG. 7 shows an additional implementation of a user interface 700. In particular, FIG. 7 depicts a first visual indication 710 of a particular health attribute of the user. The depicted health attribute in this case comprises a purchase of some Acme Ibuprofen. In at least one implementation, the health information module 520 may determine the user purchases Ibuprofen with some level of regularity. For example, the user may have mild arthritis.

The user interface template can also comprise a second visual indication 720 of an advertisement campaign indicator. In the depicted implementation, the advertisement campaign indicator comprises a health benefit for 50% off the price of Ibuprofen. Additionally, the user interface template can comprise a third visual indication 730 of an interactive object that is associated with the health-related information. In the depicted implementation, the interactive object may comprise a questionnaire. In at least one implementation, the questionnaire is provided by ABC company—the same company that manufactures the reduced price Ibuprofen. In particular, in at least one implementation, the user interface module 500 can identify the user's health attribute, identify a related health benefit in the advertisement identification module 238, and then identify an interactive object that is provided by the same company that is providing the health benefit. As such, in at least one implementation, the same company that is providing the health benefit is receiving something in return based upon the user's interaction with the interactive object (e.g., the user answering a questionnaire, the user watching an advertisement, etc.).

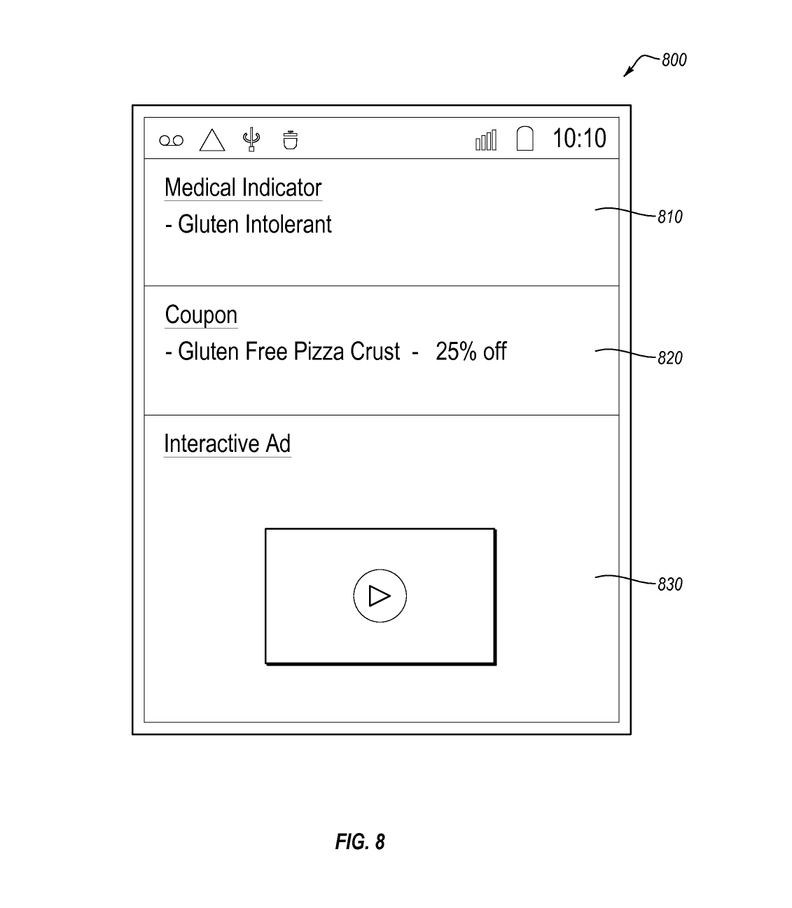

FIG. 8 shows another implementation of a user interface 800. In particular, FIG. 8 depicts a first visual indication 810 of a particular health attribute of the user. The depicted health attribute in this case comprises a gluten intolerance. In at least one implementation, the health information module 520 may determine the gluten intolerance based upon a biological metric the user provided to the electronic payment service or through a third-party information source.

The user interface template can also comprise a second visual indication 820 of an advertisement campaign indicator. In the depicted implementation, the advertisement campaign indicator comprises a health benefit for 25% off the price of a gluten free pizza crust. As such, in at least one implementation, the health benefit may not necessarily comprise a medical product, but instead can comprise a product or service that fulfills a user's health restrictions or can help improve the user's biological metrics.

Additionally, the user interface template can comprise a third visual indication 830 of an interactive object that is associated with the health-related information. In the depicted implementation, the interactive object may comprise a video. The video may comprise an advertisement for other gluten free products provided by the same company that provides the gluten free pizza crust. Once the user watches the video, the electronic payment system can store the coupon in the users benefit locker.

Once a user has fulfilled any necessary benefit activation requirements for a coupon, the coupon can be stored within a benefit locker 272 inside a user's mobile wallet 224. At a later time, the electronic payment system 221 can determine with a payment processor that the user's mobile wallet account is being used to make a purchase of a health related item. The electronic payment system 221 can then automatically check whether an advertised health benefit is stored in the benefit locker 272 of the user's mobile wallet 224. Upon determining that the advertised health benefit is stored within the benefit locker 272 of the user's mobile wallet 224, the electronic payment system 221 can generate, with the payment processor, an electronic notification that is presented to the user at the user's mobile wallet application notifying the user of the advertised health benefit. The electronic payment system can then apply the advertised health benefit from the user's mobile wallet account to the purchase of the health related item.

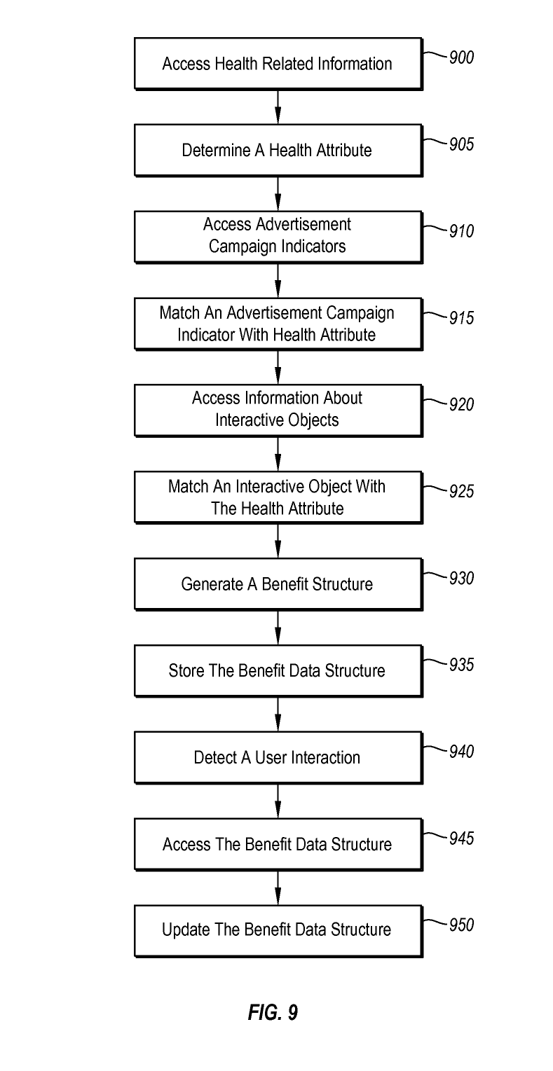

Accordingly, FIGS. 1-8 and the corresponding text illustrate or otherwise describe one or more components, modules, and/or mechanisms for managing health benefits within an electronic payment system. In particular, in at least one implementation, the present invention can determine a health attribute of a user, identify a related advertisement campaign and benefit, and identity an appropriate interactive object. One will appreciate that implementations of the present invention can also be described in terms of flowcharts comprising one or more acts for accomplishing a particular result. For example, FIG. 9 and the corresponding text describe acts in a method for managing health benefits within an electronic payment system. The acts of FIG. 9 are described below in connection with the schematics and components of FIGS. 1-4.

For example, FIG. 9 illustrates that a method for managing health benefits within an electronic payment system can include an act 900 of accessing health related information. Act 900 can comprise accessing, with a benefit determination module, health related information for a user of an electronic payment system, the user having a digital device and a mobile wallet account at the electronic payment system, the mobile wallet account being accessible to the user through a mobile wallet application running on the user's digital device. For example, FIG. 5A and the accompanying description, describe a health information module 529 that can gather health information from a database 530 or based upon the analysis of user transactions.

Additionally, FIG. 9 shows that the method can include an act 905 of determining a health attribute. Act 905 can comprise determining based upon the health related information, a particular health attribute of the user. For example, as depicted in FIG. 5A and described in the accompanying description, the health information module 520 can identify a health attribute of the user based upon the user's transactions or based upon information within a database. For instance, the health information module 520 can determine a user has a prescription based upon a repeated user transaction purchasing the prescription.

FIG. 9 also shows that the method can include an act 910 of accessing an advertisement campaign indicator. Act 910 can comprise accessing, from an advertisement identification module, one or more advertisement campaign indicators, wherein each of the one or more advertisement campaign indicators is associated with metadata that describes an advertised health benefit of each of the one or more advertisement campaign indicators. For example, FIGS. 2 and 5A and the accompanying descriptions, describe an advertisement identification module 238 that can gather information relating to advertisement campaign indicators.

Additionally, FIG. 9 shows that the method can include an act 915 of matching an advertisement campaign indicator with a health attribute. Act 915 can comprise matching the metadata associated with at least one of the one or more advertisement campaign indicators with the particular health attribute of the user. For example, as depicted in FIGS. 5A and 8 and described in the accompanying descriptions, the user interface module 500 can match a health attribute (e.g., gluten intolerance) with an advertisement campaign indicator (e.g., for gluten free pizza crust). In particular, the user interface module 500 can search through metadata associated with various advertisement campaign indicators until it identifies a “gluten” data indication. The user interface module 500 can then match the health attribute to the advertisement campaign indicator.

FIG. 9 also shows that the method can include an act 920 of accessing information about interactive objects. Act 920 can comprise accessing, from an interactive object module, information about one or more interactive objects, wherein the information describes a health attribute of each of the one or more interactive objects. For example, FIG. 5A and the accompanying description, describe an interactive object identification module 240 that can gather information relating to interactive object. For instance, the information may be gathered by accessing an external database of interactive objects that are associated with each respective company that provides an associated advertisement campaign indicator.

Additionally, FIG. 9 shows that the method can include an act 925 of matching an interactive object with the health attribute of the user. Act 915 can comprise matching the information associated with an interactive object with the particular health attribute of the user. For example, as depicted in FIGS. 5A and 8 and described in the accompanying descriptions, the user interface module 500 can match a health attribute (e.g., gluten intolerance) with an interactive object (e.g., video about other gluten-free products). In particular, the user interface module 500 can search through information associated with various interactive objects until it identifies a “gluten” information indication. The user interface module 500 can then match the health attribute to the interactive object.

In addition, FIG. 9 shows that the method can include an act 930 of generating a benefit structure. Act 930 can comprise generating a benefit data structure, wherein the benefit data structure comprises a user identification, an advertisement identification, an interactive object identification, and a user-interaction tracking metric. For example, FIG. 5B depicts an exemplary benefit data structure that was generated by the electronic payment system 221.

FIG. 9 further shows that the method can include an act 935 of storing the benefit data structure. Act 935 can comprise storing the benefit data structure in a benefit locker within the electronic payment system. For example, as depicted in FIG. 5A and described in the accompanying description, the user interface module 500 can store the benefit data structure 550 within the benefit data structure store (also referred to herein as the benefit locker 272).

FIG. 9 also shows that the method can include an act 940 of detecting a user interaction. Act 940 can comprise detecting a user interaction with the interactive object within the mobile wallet application. For example, as depicted in FIG. 5A and described in the accompanying description, the display module 510 can receive an indication that the user has interacted with the interactive object. In at least one implementation, interacting with the interactive object may comprise scanning a bar code at a gym.

Further, FIG. 9 shows that the method can include an act 945 of accessing the benefit data structure. Act 945 can comprise accessing the benefit data structure stored in the benefit locker. For example, as depicted in FIG. 5A and described in the accompanying description, the user interface module 500 can access the benefit data structure from within the benefit data structure store 550.

Further still, FIG. 9 shows that the method can include an act 950 of updating the benefit data structure. Act 950 can comprise updating the user-interaction tracking metric. For example, as depicted in FIGS. 5A and 5B and described in the accompanying descriptions, the user interface module 500 can access the benefit data structure 560 and update a user-interaction tracking metric (“customer_fullfillment”) within the benefit data structure. For example, if the interactive object comprises a video and the benefit activation requirement requires the user to watch the video, once the video has completed the electronic payment system can update the user-interaction tracking metric within the benefit data structure to indicate that the benefit activation requirement has been met.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A computer system for managing network-based electronic commerce digital communications and associated user-health information, comprising:
one or more processors;
an integration tier configured to manage mobile wallet sessions and maintain the integrity of financial transactions, wherein the integration tier also comprises a communication API to accept messages from a plurality of channels;
service connectors configured to connect to third party systems, wherein each connector is deployed as a separate module intended to integrate an external service to the system architecture;
a payment handler configured to wrap APIs of different payment processors including banking accounts, credit and debit cards or processors, wherein the payment handler exposing a common API to facilitate interactions with many different kinds of payment processors;
security services configured to perform subscriber authentication;
authorization services configured to perform client authorization using a database-based access control list table;
a data warehouse configured to manage customer accounts, manage company accounts manage transaction histories, store financial transaction details, store customer profiles, store dictionaries used by the mobile wallet platform including countries and currencies, and managing money containers;
a rules engine configured to gather financial transaction statistics and use the gathered statistics to provide transaction properties including fees and bonuses; rules engine also configured to enforce business constraints including transaction and platform license constraints; and
one or more computer-readable media having stored thereon executable instructions that when executed by the one or more processors configure the computer system to perform at least the following:
access, with a benefit determination module, health related information for a user of an electronic payment system, the user having a digital device and a mobile wallet account at the electronic payment system, the mobile wallet account being accessible to the user through a mobile wallet application running on the user's digital device;
determine, based upon the health related information, a particular health attribute of the user;
access, from an advertisement identification module, one or more advertisement campaign indicators, wherein each of the one or more advertisement campaign indicators is associated with metadata that describes an advertised health benefit of each of the one or more advertisement campaign indicators;
match the metadata associated with at least one of the one or more advertisement campaign indicators with the particular health attribute of the user;
access, from an interactive object module, information about one or more interactive objects, wherein the information describes a health attribute of each of the one or more interactive objects;
match the information associated with an interactive object with the particular health attribute of the user;
generate a benefit data structure, wherein the benefit data structure comprises a user identification, an advertisement identification, an interactive object identification, and a user-interaction tracking metric;
store the benefit data structure in a benefit locker within the electronic payment system;
generate a user interface template, wherein the user interface template comprises a first visual indication of the particular health attribute of the user, a second visual indication of the at least one of the one or more advertisement campaign indicators, and a third visual indication of the interactive object; and
send, from the electronic payment system, the user interface template to the user's mobile wallet application for presentation to the user.

2. The computer system as recited in claim 1, the executable instructions further comprising instructions that are executable to configure the computer system to:
determine that the advertised health benefit should be conferred on the user based upon the user-interaction tracking metric indicating that a benefit activation requirement has been met.

3. The computer system as recited in claim 2, the executable instructions further comprising instructions that are executable to configure the computer system to:
store the advertised health benefit in a benefit locker of the user's mobile wallet account.

4. The computer system as recited in claim 3, the executable instructions further comprising instructions that are executable to configure the computer system to:
determine with a payment processor that the user's mobile wallet account is being used to make a purchase of a health related item;
automatically checking with the payment processor whether the advertised health benefit is stored in the benefit locker of the user's mobile wallet account;
upon determining that the advertised health benefit is stored within the benefit locker of the user's mobile wallet account, generate, with the payment processor, an electronic notification that is presented to the user at the user's mobile wallet application for notifying the user of the advertised health benefit; and
apply, with the electronic payment system, the advertised health benefit from the user's mobile wallet account to the purchase of the health related item.

5. The computer system as recited in claim 2, wherein the user interface template comprises a visual indication of the benefit activation requirement.

6. The computer system as recited in claim 1, wherein the first visual indication of the particular health attribute of the user comprises an indication of when a current supply of a prescription will run out.

7. The computer system as recited in claim 1, wherein accessing health related information for the user comprises:
accessing, from a data warehouse, information relating to previous transactions processed by the user's mobile wallet account; and
identify one or more transactions that are associated with health items or services.

8. The computer system as recited in claim 1, wherein the particular health attribute of the user comprises a compliance indicator that indicates whether the user is in compliance with a particular health product or service.

9. The computer system as recited in claim 8, wherein the compliance indicator indicates one or more of the following: the current validity of a prescription associated with the user and a current amount of the prescription that the user has on hand.

10. A computer system for processing commercial transactions on a digital device, comprising:
one or more processors; and
one or more computer-readable media having stored thereon executable instructions that when executed by the one or more processors configure the computer system to perform at least the following:
display a health information entry interface for entering health-related information for a user of an electronic payment system, the user having a digital device and a mobile wallet account at the electronic payment system, the mobile wallet account being accessible to the user through a mobile wallet application running on the user's digital device;
receive health-related information from the user through the mobile wallet application;
receive, through an API at an integration tier of the electronic payment system, a user interface template, wherein the user interface template comprises:
a first visual indication of a particular health attribute of the user, wherein the particular health attribute is associated with the health-related information,
a second visual indication of an advertisement campaign indicator, and
a third visual indication of an interactive object that is associated with the health-related information, wherein the interactive object also displays a benefit activation requirement; and
display within the mobile wallet application the user interface template.

11. The computer system as recited in claim 10, wherein the third visual indication of the interactive object comprises one or more of: a video, a questionnaire, a request for the user to perform a specific action, a URL, or a request for a user to review a product.

12. The computer system as recited in claim 11, wherein the benefit activation requirement comprises one or more of: a requirement to view the video, a requirement to complete the questionnaire, a requirement for the user to perform the specific action, a requirement for the user to visit the URL, or a requirement for a user to review the product.

13. The computer system as recited in claim 12, wherein:
the benefit activation requirement comprises a requirement to visit a gym a specific number of times; and
the third visual indication of the interactive object displays a location authentication token, wherein the location authentication token is configured to validate that the user physically visited a gym.

14. The computer system as recited in claim 10, wherein the received health-related information comprises purchases made through the mobile wallet application that relate to health products and services.

15. The computer system as recited in claim 10, wherein:
the received health-related information comprises a user biological metric; and
the advertised health benefit comprises a coupon for a particular product or service that can improve the user biological metric.

16. The computer system as recited in claim 10, the executable instructions further comprising instructions that are executable to configure the computer system to:
display the user interface template within the mobile wallet application, wherein the displaying the user interface template comprises displaying:
the first visual indication of the particular health attribute of the user;
the second visual indication of the advertisement campaign indicator, wherein the second visual indication of the advertisement campaign indicator comprises a visual indication of the advertised health benefit, wherein the advertised health benefit comprises a financial incentive to purchase a particular product or service, which financial incentive is applied by the mobile wallet application; and
the third visual indication of the interactive object within the mobile wallet application, wherein the third visual indication of the interactive object also comprises a visual indication of the benefit activation requirement.

17. A method, implemented at a computer system, that includes one or more processors for managing network-based electronic commerce digital communications and associated user-health information, the method comprising:
accessing, with a benefit determination module, health related information for a user of an electronic payment system, the user having a digital device and a mobile wallet account at the electronic payment system, the mobile wallet account being accessible to the user through a mobile wallet application running on the user's digital device;
determining based upon the health related information, a particular health attribute of the user;
accessing, from an advertisement identification module, one or more advertisement campaign indicators, wherein each of the one or more advertisement campaign indicators is associated with metadata that describes an advertised health benefit of each of the one or more advertisement campaign indicators;
matching the metadata associated with at least one of the one or more advertisement campaign indicators with the particular health attribute of the user;
accessing, from an interactive object module, information about one or more interactive objects, wherein the information describes a health attribute of each of the one or more interactive objects;
matching the information associated with an interactive object with the particular health attribute of the user;
generating a benefit data structure, wherein the benefit data structure comprises a user identification, an advertisement identification, an interactive object identification, and a user-interaction tracking metric;
storing the benefit data structure in a benefit locker within the electronic payment system;
detecting a user interaction with the interactive object within the mobile wallet application;
accessing the benefit data structure stored in the benefit locker; and
updating the user-interaction tracking metric.

18. The method as recited in claim 17 further comprising:
generating a user interface template, wherein the user interface template comprises a first visual indication of the particular health attribute of the user, a second visual indication of the at least one of the one or more advertisement campaign indicators, and a third visual indication of the interactive object; and
sending, from the electronic payment system, the user interface template to the user's mobile wallet application for presentation to the user.

19. The method as recited in claim 17 further comprising:
determine with a payment processor that the user's mobile wallet account is being used to make a purchase of a health related item;
automatically checking with the payment processor whether the advertised health benefit is stored in the benefit locker of the user's mobile wallet account;
upon determining that the advertised health benefit is stored within the benefit locker of the user's mobile wallet account, generate, with the payment processor, an electronic notification that is presented to the user at the user's mobile wallet application for notifying the user of the advertised health benefit; and
apply, with the electronic payment system, the advertised health benefit from the user's mobile wallet account to the purchase of the health related item.

20. The method as recited in claim 17 further comprising:
upon receiving a user interaction with the interactive object, initializing the user-interaction tracking metric, wherein the user-interaction tracking metric comprises a timer that over time decrements that value of the advertised health benefit;
storing the initialized user-interaction tracking metric to the benefit data structure; and
upon receiving another user interaction with the interactive object, accessing the benefit data structure and adjusting the timer such that the value of the health benefit is incremented.
